(19) United States
(12) Patent Application Publication
(10) Pub. No.: US 2010/0274741 A1
(43) Pub. Date: Oct. 28, 2010

(54) Metals Mass Production and Small Run Reduced Weight Products and Methods of Producing the Same with Automatic and Numerically Controlled (NC) Hydraulic Punching and Flame Cutting Machinery including a 5 Axis NC Machine with Two Bi-Directional Angling Pivot Joints and Two Telescoping Axis Arms and One Main Carriage for Products involved in Building Construction, Bridges, Automobiles, Airplanes, and Mill Stocks including I-Beams, Channel, Angle, Flat Stocks, and Square Tubing

(76) Inventor: Michael Robert Thomas, N. Ft. Myers, FL (US)

Correspondence Address: MICHAEL R. THOMAS INVENTING CONSULANT, 189 Evergreen Rd., NORTH FORT MYERS, FL, 33903, US

(21) Appl. No.: 12/582,876

(22) Filed: Oct. 21, 2009

Related U.S. Application Data
(60) Provisional application No. 61/107,096, filed on Oct. 21, 2008.

(51) Int. Cl. G06Q 90/00; B23P 17/00; E04H 12/00

(52) U.S. Cl. 705/500; 29/650; 52/650.1

(57) ABSTRACT

This invention pertains to all steel, aluminum, and alloys, in all available in stock forms and built up assembles from 10′ to 400′ or more in length, that can be weight reduced pattern processed without reducing structural integrity by numerically controlled (NC) multiple hole circular flame cutting punch, or NC plasma hole cutting machine, or NC horizontal and vertical pattern hole punching machine with hot liquid metal or water cooling. The hot scrap metal furnace return conveyer saves energy. The pattern holes formed will allow for precision cutting and cross piece intersection fastener placements. The I-beam building construction system features accurate pattern no holes cutting necessary bolt and bracket fastening methods. The NC machine accepts circular flame torch cutting and pivoting six or eight sided turret head providing five sided machining access for medium and large work pieces from 10′ to 400′.

Title: Metals Mass Production and Small Run Reduced Weight Products and Methods of Producing the Same with Automatic and Numerically Controlled (NC) Hydraulic Punching and Flame Cutting Machinery including a 5 Axis NC Machine with Two Bi-Directional Angling Pivot Joints and Two Telescoping Axis Arms and One Main Carriage for Products involved in Building Construction, Bridges, Automobiles, Airplanes, and Mill Stocks including I-Beams, Channel, Angle, Flat Stocks, and Square Tubing

### DRAWING DESCRIPTIONS AND SPECIFICATIONS NUMBERED

Metal structural weight reduction processes include metal punching, flame cutting, and plasma cutting. All thicknesses and dimensional sizes and multi-piece constructions riveted or bolted into assemblies of metals will be affected from 1½″×1½″ to 10′×10′ or more and ⅛″ to 1″ or more depending on the size of the metal piece to be created. The process will reduce weights 20-40% depending on tested safety levels.

FIG. 1 I-Beam Side View Structural Steel (Horizontal /Vertical Plus Cross Support Configuration) Skyscrapers, Bridges, and Small Stock

FIG. 2 I-Beam End View Horizontal and Vertical I-Beam

FIG. 3 Angle Metal End View Horizontal

FIG. 4 End View Flat Stock Metal

FIG. 5 End View Angle Channel Horizontal or Vertical

FIG. 6 End View Square Channel Horizontal or Vertical

FIG. 7 End View Square or Rectangular Welded Tube Steel

FIG. 8 End View Square or Rectangular Welded Tube Steel

FIG. 9 I-Beam Side View Structural Steel (Large Hole/Small Hole Configuration)

FIG. 10 Side View showing the Intersection of a Vertical and a Horizontal I-Beam or Square Tube with Nut and Bolted Brackets (4 Places). Detail 1. Large Nut and Bolt (Typical All Figures—2 Places each Bracket Space). Detail 2. Side View L-Bracket also shown in FIG. 12, Detail 2. Detail 3. Large Hex Head Bolt (4 Places) Plus Small Hex Head Bolt (4 Places). Detail 4. L-Angle Bracket 1 on each Side of the Beam used with or without Angle Bracket shown in as Detail 2. Detail 5. Small Punch Holes (⅜″ to 1½″ in Diameter depending on Size of Structural Member) from Hydraulic Punch shown in FIGS. 13, 17, and 18, Detail 6. Large Punch Holes (⅝″ to 2″ in Diameter depending on Size of Structural Member) from Hydraulic Punch shown in FIGS. 13, 17, and 18

FIG. 11 Side View of Splice Plates for Joining Two I-Beam Channel or Square Tubing together

FIG. 12 Top View of the Intersection of Two Pieces of I-Beam and a Vertical Piece of Punched I-Beam, Detail 1. End View Vertical I-Beam with Punched or Plain Cut Holes, Detail 2. Angle Bracket (2 Place on Both Sides of Beam) Plus (2 Places on the Bottom Side of Beam) as shown in FIG. 10

FIG. 13 Top View Hot Extrusion or Cold Horizontal and Vertical Metal Punch for I-Beam, Flat Stock, Thick Sheets, Channel, or Angled, Metals. Detail 1. Multiple Power Cylinder Punch Line Horizontal Movement for Metal Stock Piece Lengths 3′ to 50′ or Longer as shown in 3 Places. Detail 2. Power Cylinder Fluid Reservoir each Cylinder. Detail 3. Steel Block attached to Power Cylinders and Individual Horizontal Punches (3′ to 50′ Long or Longer and also shown as in FIG. 18, Detail 3). Detail 4. Power Cylinder Piston. Detail 5. Left Side Multiple Power Cylinder Block (3′ to 50′ Long). Detail 6. Individual Metal Punches (1 per Hole—3′ to 50′ Long Rows shown Retracted Position also shown in the Extended Position in FIG. 18, Details 2 and 4). Detail 7. Top View of Hot Mill Extrusion Die for Various Metal Piece Configuration I-Beam shown and shown in FIG. 16. Detail 8. Top View Work Piece I-Beam shown with Punch Holes Top and Cross Punch Holes at the Right Side of the Beam. Detail 9. Power Cylinder for Vertical Punch Movement for 3′ to 50′ Long Pieces as shown in FIG. 17, Detail 1. Detail 10. Right Side Multiple Power Cylinder Block (3′ to 50′ Long). Detail 11. Side View of FIG. 13 Details 5, 9, and 10, showing Power Cylinder Row and Detail 15 showing ACME Screw Threaded Full Die Assembly and including Detail 14 a Square Stock Stabilizing Rod for Full Die Assembly Movement. Detail 12. Punch Force Resistant Plate Block (Both Sides of Punch Die) connected with Bolts as Necessary shown in Detail 16 to Resist the Force of Punching, Length to be Determined by the Finished Length of the Die Assemble 3′ to 50′ Long. Detail 13. Square Stock Stabilizing Rod and ACME Screw Thread Assembly for Full Die Movement (1 Located over the Top of the Other as shown in Details 15 and 14) 6′ to 50′ Long depending on Durability Estimates (Typical Both Sides). Detail 14. Square Bar Stock Rod for Stability of Full Machine Carriage Movement (Two Places—One Each Side of Carriage). Detail 15. ACME Screw Threaded Rod (10′ to 100′ Long—Two Places—One Each Side of Carriage) for Precision Movement of Machine Carriage to Maintain Spacing Accuracy for Repetitive Punching or Flame Cutting along Work Piece Length. Detail 16. Nuts and Bolts (Top and Bottom) Spaced as Necessary to Resist Punching Forces along the Entire Length of the Punching Die Assembly

FIG. 14 I-Beam shown with Horizontal Punching Function Completed

FIG. 15 I-Beam shown with Vertical Punching Function Completed

FIG. 16 I-Beam Extrusion Die Liquid Metal Cooled as shown in FIG. 13, Detail 7

FIG. 17 Vertical I-Beam Punch or Plasma Cutter with I-Beam in Place with Power Cylinders and Blocks in the Extended Position as shown in Top View of Details 8 and 9, Detail 1. Power Cylinder Multi-Location along 3′ to 50′ Long Work Piece for Punch or Plasma Cut Holes, also shown in Details 1, 2, and 4, and FIGS. 18 and 19

FIG. 18 Horizontal Metal Stock Punch with I-Beam in Place as shown in FIG. 13, Details 6, 3, and 4. Detail 1. I-Beam as shown in FIG. 17, FIG. 13 Detail 8, and FIGS. 14, 15, and 16. Detail 2. Large Diameter Solid Hole Punch for Hot Extrusion Process Extending through Die Block. Detail 3. Die Block with attached Hole Punches, Large and Small, 3′ to 50′ Long. Detail 4. Small Diameter Solid Hole Punch for Hot Extrusion Process Extending through Die Block. Detail 5. Internal Die Block Gray Area Milled out for Easy Punch Slug Droppings into Conveyer Tray shown in FIG. 20. Detail 6. Liquid Metal or Water Die Cooling as Necessary to Eliminate Overheating

FIG. 19 Vertical Metal Stock Hydraulically Operated Hole Punch using Flame or Plasma Cutting, 3′ to 50′ Long Cutting Die as shown in FIG. 13. Detail 1. Hydraulic Cylinder Extended. Detail 2. Small Torch Head for Flame or Plasma Cut. Detail 3. Large Torch Head for Flame or Plasma Cut. Detail 4. External Ring Only Flame Cutting Head. Detail 5. External Ring Only Plasma Cutting Head. Detail 6. External Ring Flame produces Metal Slug after each Hydraulic Cylinder Movement, Flame appears only in a Outer Circular Ring Area of the Torch Head. Detail 7. Feed Holes for Individual Flame Cutting Heads for Gas, Air, Acetylene, Oxygen

FIG. 20 Scrap Tray and Conveyer Assembly as shown Servicing FIGS. 17, 18, and 19. Detail 1. Metal Slugs from Punch Die or Flame Cut Die for Scrap Bin or Conveyer Return to Furnace. Detail 2. Scrap Conveyer for Return to Furnace or Scrap Bin

FIG. 21 Side View of a Four Axis Numerically Controlled Telescoping Arm Robotic Flame or Plasma Torch Cutter or Milling and Drilling Machine, ACME Screw Thread or Round Gear and Toothed Square Bar Operated, Multi-Staged Square Tubing Encased. Detail 1. Numerical Control Center. Detail 2. Vertical Lift or Lowering Flat Gear and Motor Assembly (1 or 2 Places depending on the Number of Telescoping Arm Square Tube Sections) as shown in FIG. 26. Detail 3. Two or Three Section (Three Shown) Horizontal Square Tubing, Telescoping Arm Extension Stages, Extended to End Point, also Three Vertical Stages shown in FIG. 21 Drawing, Section Sizes 16″ to 48″ Square by 2′ to 20′ Long. Detail 4. Motor for 180 Degree Plus Pivoting Head Movement. Detail 5. Motor for Machine Tool Drive or Rotational Flame Hole Cutting. Detail 6. ACME Threaded Rod for Main Table Movement (6′ to 100′ Long). Detail 7. Round Gear and Toothed Square Bar Operated Main Table Movement and/or ACME Thread Main Table Movement as shown above Detail 7. Detail 8. Gas Cylinder for use with Torch Head shown in Detail 5. Detail 9. Torch Head Various Types, Plasma or Flame, Standard or Ring Type or Mill, Drills, Reamers, etc. Detail 10. Telescoping Arm Section Removable with Flat Gear and/or ACME Threaded Rod Numerically Controlled Extension/Retraction Drive. Detail 11. Double Directional Geared 180 Plus Degree Pivoting Head, Manual Version or with Side or Internal Mounted Motor.

FIG. 22 End View Work Piece sitting on Long Stationary Work Table (6′ to 30′ Wide and 20′ to 200′ Plus Long) such as Bridge Metal Support Beam for Pattern Metal Weight Reduction as shown in FIG. 24, Detail 1. Hold Down Brackets on Both Sides of Work Table and Machine Carriage

FIG. 23 Top View of a Four Axis Numerically Controlled Telescoping Arm Milling, Drilling, and Torch Cutting, Machine mounted on Dual Carriage Ways (3′ to 20′) with and without Six Sided Indexing Turret. Detail 1. Carriage Ways 10′ to 200′ Long or Longer. Detail 2. Top View of ACME Threaded Rod for Telescoping Arm Square Tubing Extension as shown in and FIG. 26 Detail 1. Detail 3. Top View of Bottom ACME Threaded Rod for Telescoping Arm Square Tubing Extension as shown in FIG. 26 Detail. Detail 4. Top View of Top ACME Threaded Rods for Telescoping Arm Square Tubing Extension as shown in FIG. 26 Details 1 and 2 also shown in FIG. 23 Details 2 and 3. Detail 5. Two Directional Pivoting Electrical Motor. Detail 6. Motor for Machine Tool Drive, Mills, Drills, Torch, etc. Detail 7. Single Tool Chuck Set Screw Type Morris Tapered Chuck for Vertical Milling, Drilling, or Torch Cutting, Head Assembly

FIG. 24 Side View of Work Piece Pattern or Hole Type as shown in FIGS. 1 through 9, also shown as a work piece in FIG. 22.

FIG. 25 Top View of Triple Square Tubing Telescoping Arm Machine Extension Sections with Motor Brackets as used in FIG. 21. Detail 1. Top View of Milled Gear attached to Center Shaft and Electric Motors in Various Machine Placements as shown in FIG. 21 Detail 2. Detail 2. Electric Motor as shown in FIG. 21 Four Places. Detail 3. Circular Milled Multi-Toothed Gear. Detail 4. Top View or End Retracted Telescoping Arm Extension Section.

FIG. 26 End View Double Bracketed Motors, Gears, Drive Shafts, and ACME Threaded Extension Rods. Detail 1. Solid Center Shaft of ACME Threaded Rod. Detail 2. Brackets Top and Bottom of Telescoping Arm Section as shown in FIG. 23 Detail 4.

FIG. 27 Top View of Hexagon Machine Tool Turret Head. Detail 1. Reamers and Small Drills. Detail 2. Rough and Finish End Mills. Detail 3. Fly Cutters.

FIG. 28 Top View of Vertical Position Turret Head 90 Degree Angle Pivoted Position Mounted attached to Telescoping Arm Machine Toolas shown in FIG. 23. Detail 1. Six Side Horizontal Vertical Mounted Turret Head. Detail 2. Turret Head Pivoting Motor. Detail 3. Pivoting Turret Pivoting Gear Box.

FIG. 29 Top View of Vertical Position Turret Head Straight Ahead Pivoted Position Mounted attached to Telescoping Arm Machine Toolas shown in FIG. 23. Detail 1. Side View Motor, Single or Double, as Necessary for Turret Operation and Tool Spin. Detail 2. Side View Hex or Octagon Rotating Tool Turret Detail 3. Pivoting Motor shown in Retracted Position, also shown in FIG. 28 Detail 2 Detail 4. Double Directional Geared 180 Plus Degree Pivoting Head with or without Top Mounted Motor FIG. 30 Top View Five Axis Telescoping Arm Machine Tool Mounted attached to Six or Eight Face Machine Tool Turret. Detail 1. Side View Hex or Octagon Rotating Tool Turret. Detail 2. Double Directional Geared 180 Plus Degree Pivoting Head with or without Top Mounted Motor. Detail 3. Top View Five Axis Underside Position Turret Head 90 Degree Angle Pivoted Position Mounted attached to Telescoping Arm Machine Tool. Detail 4. Side View Motor, Single or Double, as Necessary for Turret Operation and Tool Spin

What is claimed is:

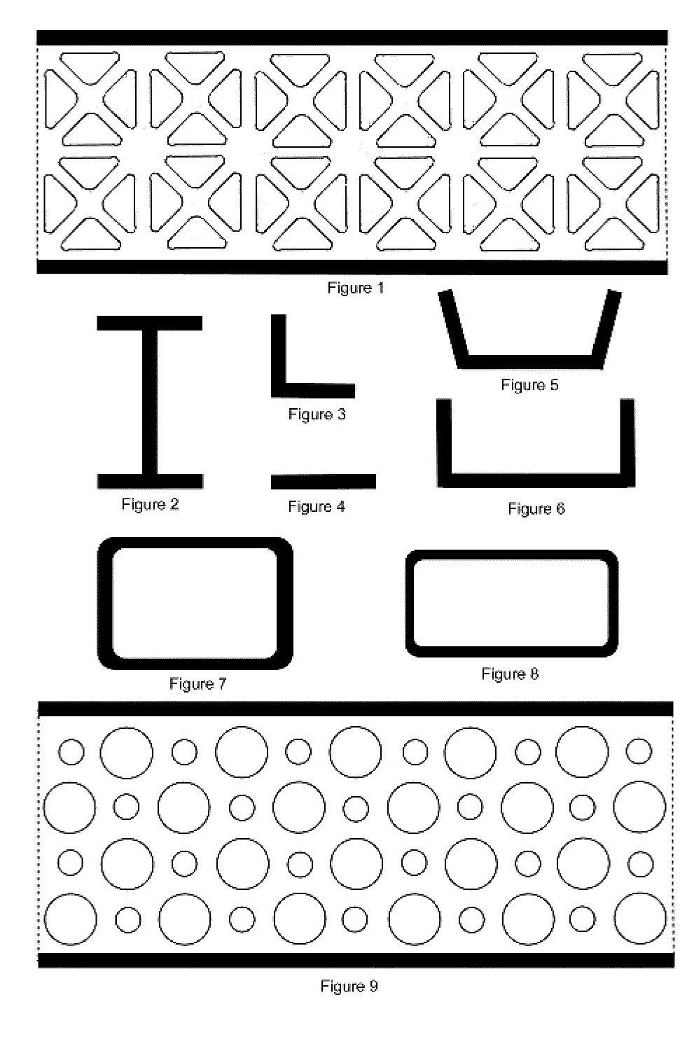

1. Claimed in this invention of formed metal products including the following;
(a) The conception of metals processing for the purpose of reduced structural metal pieces construction cost (See FIGS. 1 through 9).
(b) Reduced cost metal products (See FIGS. 1 through 9).
(c) In-stock available lightened metal products (See FIGS. 1 through 9).
(d) Structural metal I-beam channel, flat bar stock, square tube, and L-angle, 10, 20, and 50 ft. lengths, in reduced weight patterned configurations (See FIGS. 1 through 9).)

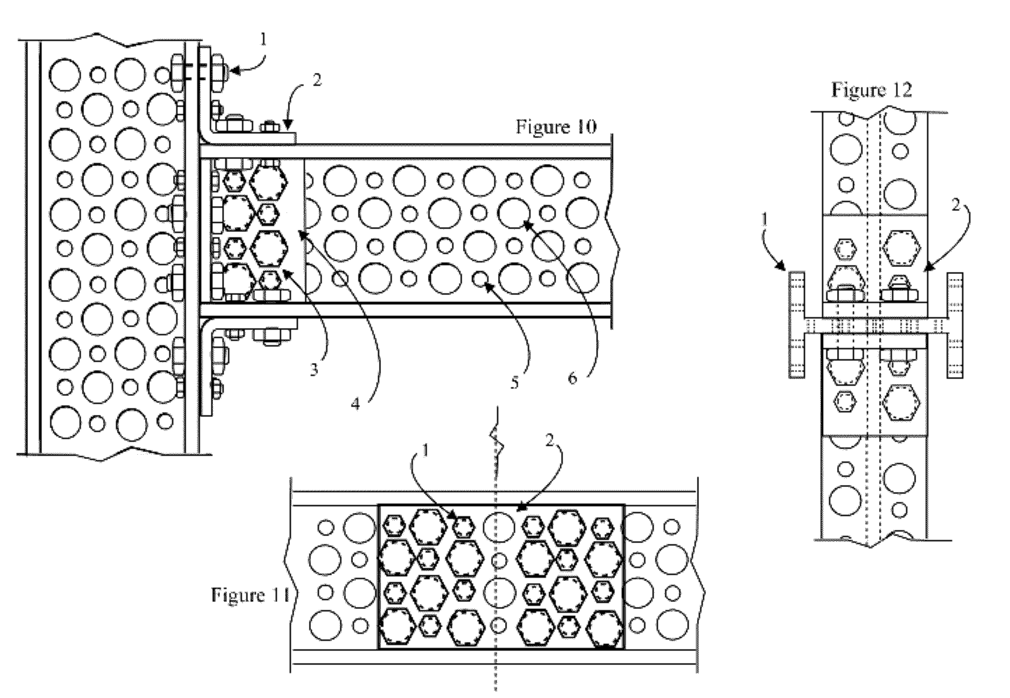

2. Claimed in this invention are a metals building construction system including the following;
(a) Fasteners to be used in conjunction with the lightened metals building construction system (See FIGS. 1 through 9).
(b) Lightening of metal assemblies for the purpose of improving load bearing capabilities of the structure (See FIGS. 1 through 9).
(c) A new building and sky scraper construction system requiring no welding and pre-drilled and measured holes for bolts (See FIGS. 10 through 12).
(d) Matching brackets to punched holes for exact measurement structural member intersections (See FIGS. 10 through 12).
(e) Improved strength structural member mounting brackets (See FIGS. 10 through 12).
(f) A new building and skyscraper system that combines precision no welding pre-punched holes with the economy of weight reduced structural beams (See FIGS. 10 through 12).

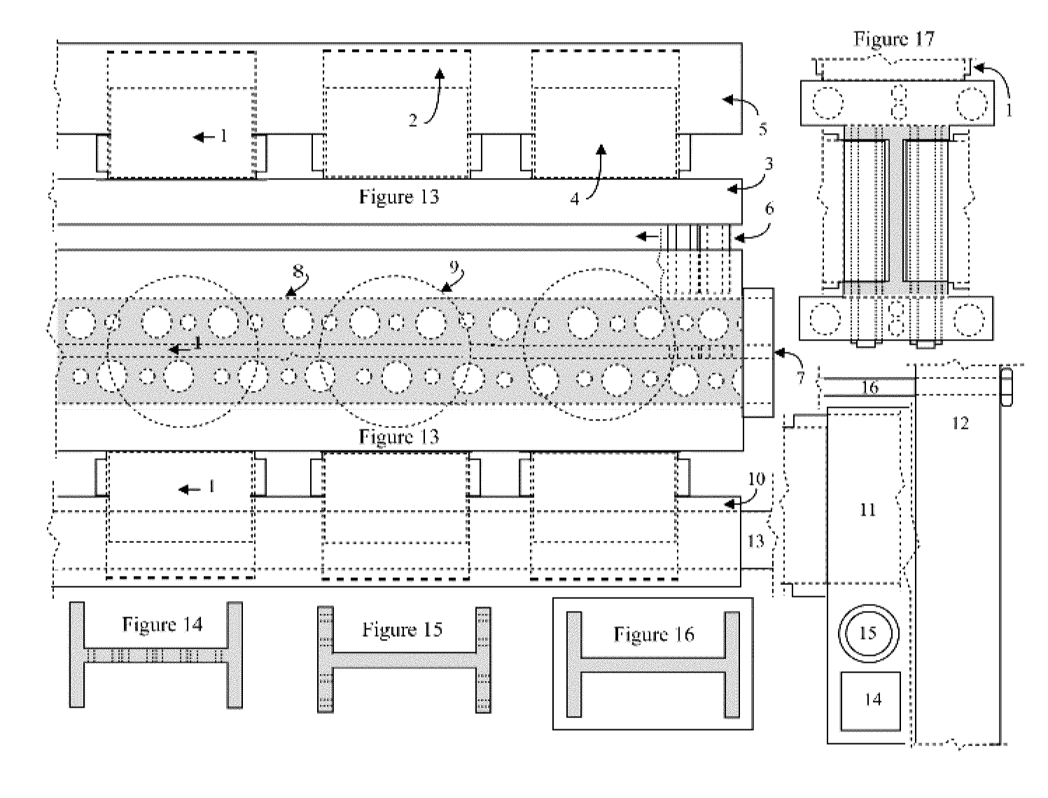

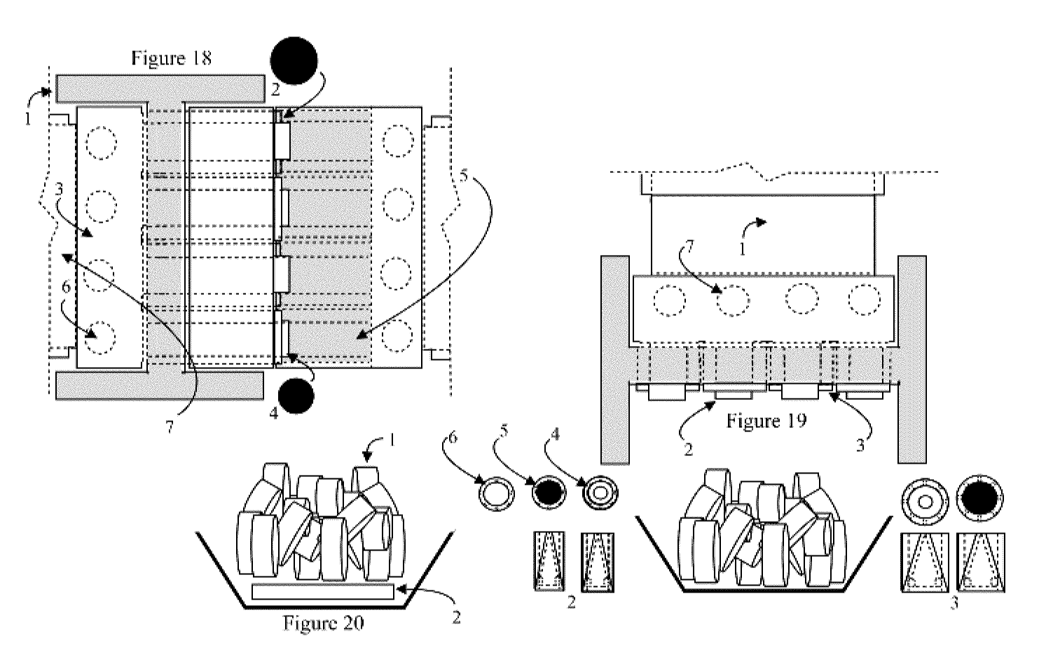

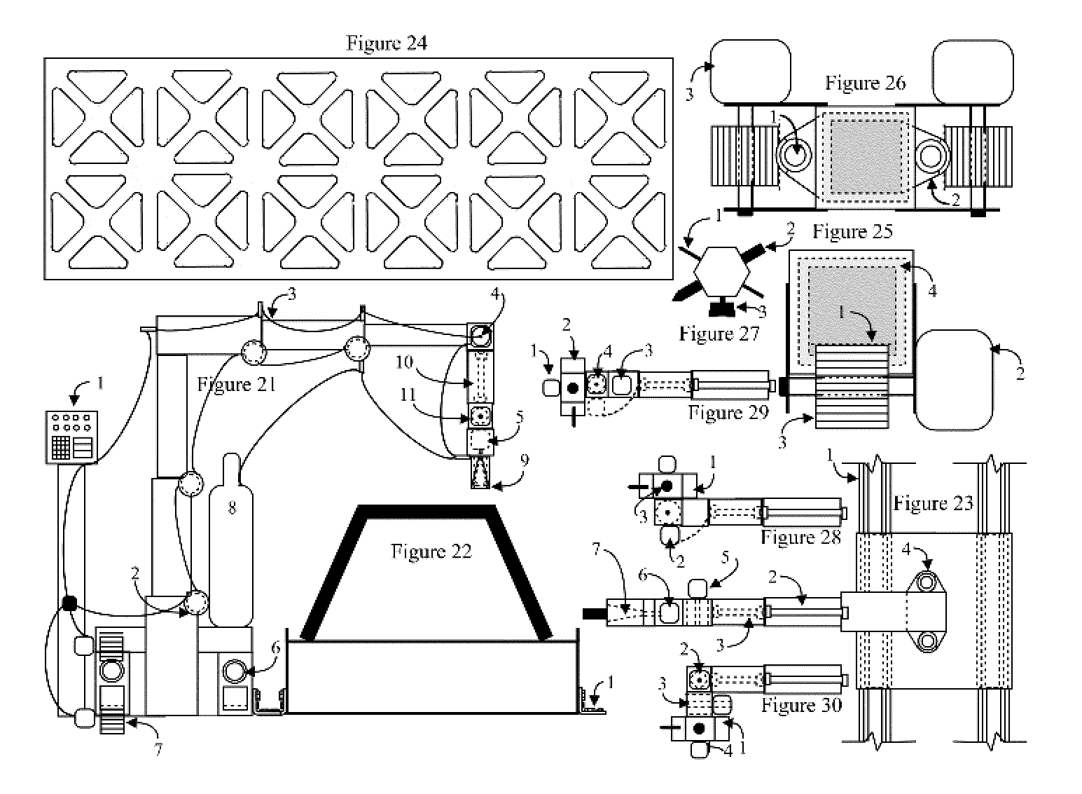

3. Claimed is the invention of metal processing machinery including the following;
(a) Lightened metal stocks through pattern punching and flame cutting for all metals including steels, aluminum, and alloys (See FIGS. 1 through 9).
(b) Fixed pattern flame cutting, metal punching, and milling, for the purpose of reduced cost metal products (See FIGS. 1 through 9).
(c) Steel mill hot punch extrusion process for I-beams, channels, flat stocks, and pre-bent square tubing flat stock (See FIGS. 13 through 17).
(d) Power cylinder driven dies and machinery capable of punching or flame cutting metal (See FIGS. 13 through 17).
(e) Two directional, horizontal and vertical, metal punching dies (See FIGS. 13 through 17).
(f) Multi-hole dies for metal punching (See FIGS. 13 through 17).
(g) Multi-hole dies for flame cutting (See FIGS. 13 through 17).
(h) Machinery capable of punching I-beam sections 100′ long in increments of 1′ to 50′ (See FIGS. 13 through 17).
(i) Repetitive multi-hole die punching or flame cutting with accurate repetitive punching along long length work pieces (See FIGS. 13 through 17).
(j) Energy saving hot punched metal conveyer for return of hot scraps to the furnace (See FIGS. 18 through 20).
(k) External ring only plasma torch cutting heads (See FIGS. 18 through 20).
(l) External ring only flame cut torch cutting heads (See FIGS. 18 through 20).
(m) Multiple holed punch dies with milled out scrap drop areas (See FIGS. 18 through 20).
(n) Multiple holed flame cut or plasma cut dies (See FIGS. 18 through 20).
(o) Five axis numerically controlled (NC) flame and plasma cutting industrial robot (See FIGS. 18 through 20).
(p) 5 axis numerically controlled (NC) milling machine (See FIGS. 18 through 20).
(q) Multi-telescoping arm numerically controlled (NC) machine and two methods of controlling movement of the telescoping sections, ACME screw thread type as shown in FIG. 21 detail 2 and gear driven as shown in FIG. 23 details 2 and 3 (See FIGS. 18 through 20).
(r) Single and double multi-position angle pivoting joint for a numerically controlled machine arm (See FIGS. 18 through 20).
(s) Multi-positioning 6 or 8 face turret machine tool head used in conjunction with numerically controlled (NC) mills and the usage with telescoping arm NC machines (See FIGS. 18 through 20).
(t) Numerically controlled (NC) turrets used in conjunction with single and double motorized adjustable angle pivoting joints as shown in FIG. 30 details 2 and 3 and single version as shown in FIG. 23 detail 5 and FIG. 29 detail 4 and FIG. 21 item 4 (See FIGS. 18 through 20).
(u) Extended length bed way numerically controlled (NC) machine for medium and large work pieces (See FIGS. 18 through 20).
(v) Numerically controlled (NC) machine capable of completing all machining operations on large and small work pieces without changing work piece position (See FIGS. 18 through 20).
Purpose and Usefulness
1.) The new system will conserve metal ores for future generations.
2.) The new system will reduce unsightly strip mining.
3.) The new system will reduce airborne and thermal pollution.
4.) The new system will reduce the amount of metal necessary to produce standard configurations of metal objects thereby allowing 20-40% more objects to be produced with the same amount of metal.
5.) The new system will reduce materials cost per metal object unit by 20%-40%.
6.) The new system will improve fuel economy in all moving vehicles by reducing vehicle weight.
7.) The new system will improve the fuel economy of the vehicles delivering products thereby helping to reduce air pollution and promote increased hauling capacities of the vehicle.
8.) The new metal piece configurations will allow for reduced structure weight of completed structures thereby allowing higher structures to be built or weight load increases on the structure.
9.) The new invention will lighten bridges, building construction, ships, machinery, equipment, truck and automobile frames, aircraft, military vehicles, metal bar and beam stocks, and all other applications of these types of metal usage.
10.) The new multi-punch and flame cut machinery will produce products far faster than the old single punch or flame cut method thereby reducing labor costs and increasing productivity and profits.
